(19) United States
(12) Patent Application Publication
(10) Pub. No.: US 2026/0038389 A1
(43) Pub. Date: Feb. 5, 2026

(54) TECHNIQUES FOR LANGUAGE LEARNING

(71) Applicant: Flashlight Learning, Inc., Draper, UT (US)

(72) Inventors: JUSTIN HEWETT, Draper, UT (US); CATHY OSHEL, Georgetown, TX (US); JENNY MEESKE, Los Gatos, CA (US); JUDSON HART, Orem, UT (US); JACOB BURDIS, Rigby, ID (US)

(73) Assignee: Flashlight Learning, Inc., Draper, UT (US)

(21) Appl. No.: 19/287,242

(22) Filed: Jul. 31, 2025

Related U.S. Application Data
(60) Provisional application No. 63/678,029, filed on Jul. 31, 2024.

(51) Int. Cl. G09B 19/06; G09B 7/04

(52) U.S. Cl. CPC G09B 19/06; G09B 7/04

(57) ABSTRACT

Techniques for language learning are disclosed. An apparatus is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

### CROSS-REFERENCE TO RELATED APPLICATIONS

This application claims the benefit of U.S. Provisional Patent Application No. 63/678,029 entitled “LANGUAGE LEARNING” and filed on Jul. 31, 2024, for Justin Hewett, et al., which is incorporated herein by reference.

### FIELD

This invention relates to learning and more particularly relates to techniques for language learning.

### BACKGROUND

Learning a new language can be difficult, frustrating, and time consuming. Technology such as computers, smart devices, or the like, however, can facilitate and assist users in learning a new language.

### SUMMARY

In one embodiment, an apparatus is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

In one embodiment, a method is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

In one embodiment, a computer program product includes a non-transitory computer-readable storage medium that stores program code that, when executed by one or more processors, is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is diagram of a system for language learning in accordance with the subject matter disclosed herein.

FIG. 2 is a diagram of an apparatus for language learning in accordance with the subject matter disclosed herein.

FIG. 3 illustrates one embodiment of a method for language learning.

FIG. 4 illustrates one embodiment of a method for language learning.

FIG. 5 illustrates one embodiment of a method for language learning.

### DETAILED DESCRIPTION

Learning a new language—particularly in academic K-12 settings—is a multidimensional challenge. Traditional platforms for English Language Learners (ELLs) often rely on static curricula, non-contextual grammar drills, and generic feedback, all of which fall short of eliciting meaningful student engagement or aligning with actual classroom content. Moreover, early-grade learners frequently lack the typing fluency required by many digital tools, and most existing systems fail to offer effective scaffolding that connects language tasks to academic standards or classroom material. As a result, students may receive surface-level scores without understanding how to improve, and teachers are often left without actionable insights into learner progress.

To address these limitations, the solutions discussed herein present a language learning system that is centered around dynamically generated image prompts and personalized feedback. The system allows teachers to select content-relevant images (e.g., from science or social studies units), and from those images, it generates a range of leveled prompts-labeling, sentence completion, open-ended writing, and speaking-tailored to the student's proficiency and curriculum. By reusing a single image across multiple tasks, the system supports natural scaffolding of language development while staying anchored in meaningful content. The same image may guide students from basic vocabulary identification to analytical explanation, integrating visual thinking with language output in a structured but flexible format.

A central feature of the system is its capacity to provide highly granular, individualized feedback that directly informs the student how to improve. Each response—whether typed, spoken, or submitted as a photo of handwritten work—is scored across multiple indicators, such as grammar, fluency, vocabulary, and interpretation, with reference to rubrics aligned to state and national English language development standards. Students are not merely shown a score, but are told precisely what they did well and what they need to do better. This feedback is accessible directly to students, helping them track their own growth over time and creating a motivational feedback loop that fosters continued engagement. Teachers, in turn, can define goals, adjust instruction, and monitor trends in both individual and group performance.

Artificial intelligence (AI) plays a supporting role throughout the system. It is used to auto-score responses based on models trained on a proprietary corpus of thousands of human-graded responses across grade levels and tasks. If AI scores diverge from human scores, the platform automatically flags those responses for quality review. AI is also used to generate prompts and reading passages based on selected images and student proficiency levels, and to recommend instructional resources in real time. By combining teacher-led content selection, rich image-driven prompts, adaptive AI-backed scoring, and feedback that students can act on immediately, the system closes the instructional loop in a way that traditional language learning platforms do not—and cannot—achieve.

Thus, unlike conventional language learning approaches that merely digitize static instructional content, the solutions herein provide a concrete and technical solution to the challenge of delivering adaptive, standards-aligned language instruction through a unified system architecture. The claimed solution is not directed to an abstract idea in isolation, but rather to a specific implementation of a language learning platform that integrates image-based scaffolding, individualized feedback generation, rubric-aligned scoring, and adaptive task sequencing—all executed by a system of interconnected processors and memory modules. These features, especially when combined with real-time student performance analysis and seamless integration of spoken and handwritten input, yield improvements in both the functioning of the system itself and in the user's educational outcomes. Accordingly, the invention provides significantly more than the mere automation of mental steps or educational principles and instead offers a novel and practical improvement in the field of computer-facilitated language instruction.

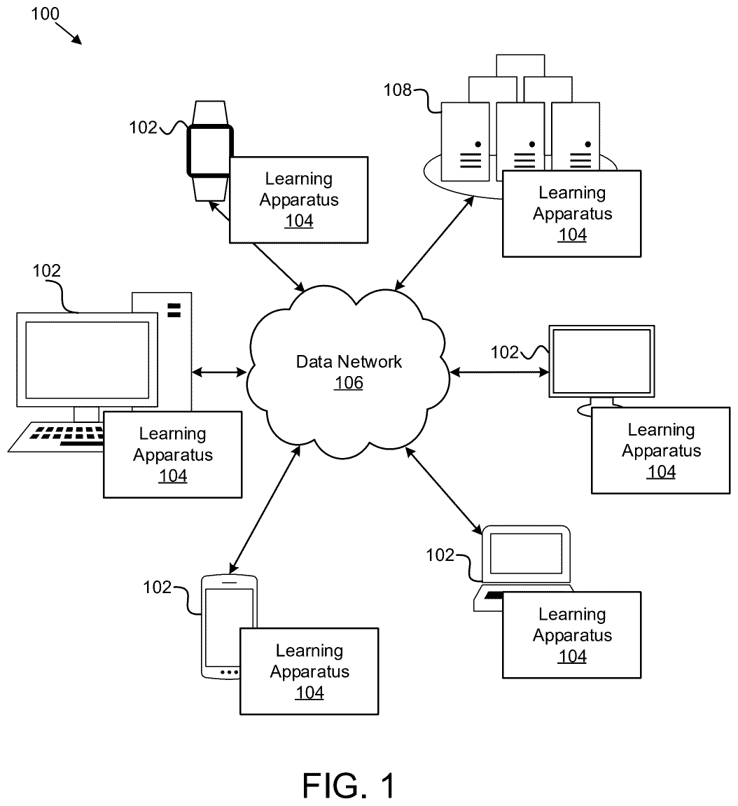

FIG. 1 is a schematic block diagram illustrating one embodiment of a system 100 for techniques language learning. In one embodiment, the system 100 includes one or more information handling devices 102, one or more learning apparatuses 104, one or more data networks 106, and one or more servers 108. In certain embodiments, even though a specific number of information handling devices 102, learning apparatuses 104, data networks 106, and servers 108 are depicted in FIG. 1, one of skill in the art will recognize, in light of this disclosure, that any number of information handling devices 102, learning apparatuses 104, data networks 106, and servers 108 may be included in the system 100.

In one embodiment, the system 100 includes one or more information handling devices 102. An information handling device 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, an FPGA or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In general, in one embodiment, the learning apparatus 104 facilitates language learning. In one embodiment, the learning apparatus 104 is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

In certain embodiments, the learning apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the learning apparatus 104 may include a power interface, a wired and/or wireless network interface, a graphical interface that attaches to a display, and/or a semiconductor integrated circuit device as described below, configured to perform the functions described herein with regard to the learning apparatus 104.

The learning apparatus 104, in such an embodiment, may include a semiconductor integrated circuit device (e.g., one or more chips, die, or other discrete logic hardware), or the like, such as an FPGA or other programmable logic, firmware for an FPGA or other programmable logic, microcode for execution on a microcontroller, an ASIC, a processor, a processor core, or the like. In one embodiment, the learning apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the learning apparatus 104.

The semiconductor integrated circuit device or other hardware appliance of the learning apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the learning apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. Functionally, the one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to store network security policies including website information, e.g., website validity/reputation scores, website access lists, and/or the like. The servers 108 may further be configured to execute or run network security algorithms, programs, applications, processes, and/or the like such as maliciousness analysis programs, data sensitivity analysis programs, granular action control analysis programs, and request body control analysis programs.

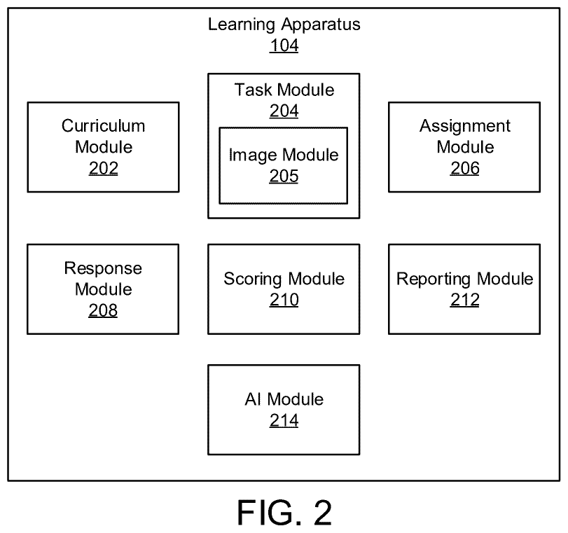

FIG. 2 depicts one embodiment of an apparatus for language learning. In one embodiment, the apparatus includes an instance of a learning apparatus 104. The learning apparatus 104, in one embodiment, includes one or more of a curriculum module 202, a task module 204, an image module 205, an assignment module 206, a response module 208, a scoring module 210, and a reporting module 212, described in more detail below.

In one embodiment, the curriculum module 202 is configured to receive, access, reference, determine, or otherwise identify a curriculum for language learning. As used herein, a “curriculum” may include courses, units, lesson plans, instructional sequences, and associated learning materials designed to achieve targeted educational objectives. These objectives may relate to language acquisition, academic vocabulary, content-specific comprehension (e.g., in science or social studies), or cross-disciplinary goals. The curriculum may originate from district-authorized resources, national or state education authorities (e.g., the U.S. Department of Education, state departments of education, or the like), or other organizations that define grade-level academic standards. The curriculum module 202 is further configured to associate the received curriculum with one or more content-aligned standards such as Common Core, Next Generation Science Standards (NGSS), World-Class Instructional Design and Assessment (WIDA), or English Language Proficiency (ELP) standards. In one embodiment, the curriculum module 202 stores a mapping between these standards and internal instructional structures—such as task types, prompt templates, and expected language output—thereby enabling downstream modules to dynamically align instructional content with mandated learning outcomes.

In one embodiment, the curriculum module 202 is configured to ingest curriculum data through one or more input methods, including direct file upload (e.g., PDFs, Word documents, spreadsheets), connection to a learning management system (LMS), scraping of designated URLs, or access to a remote or cloud-based file directory. Once acquired, the curriculum module 202 may apply a combination of natural language processing (NLP), pattern matching, and AI models to extract and parse learning objectives, performance expectations, and associated metadata such as grade level, domain (e.g., science, math, English), or student proficiency band. For example, the curriculum module 202 may identify and extract an objective such as “Use key details to describe the life cycle of a plant” and tag it with properties indicating alignment to a third-grade science unit and Tier 2 vocabulary expectations. These tags are used by other components of the system—such as the task module, image module, and scoring module—to ensure that language practice activities are educationally grounded and standards-aligned.

In some embodiments, the curriculum module 202 further enables users—such as teachers or instructional leaders—to define specific learning goals for an individual student or group of students. These goals may include curriculum-linked objectives (e.g., “describe cause and effect in historical events”), language targets (e.g., “use transitional phrases in writing”), or rubric-based performance thresholds. The system may treat these goals as additional inputs that guide the selection or generation of prompts and instructional tasks. For example, if a teacher defines a goal that a student should improve their use of content-specific vocabulary in speaking tasks, the system may prioritize prompts and activities that elicit spoken descriptions of labeled image scenes rich in academic terminology. The goals may also function as override mechanisms that influence real-time decision logic used by the task module to determine the next instructional step based on current performance and curricular alignment.

In certain embodiments, the curriculum module 202 maintains a record of previously assigned standards, objectives, or instructional activities for a given student or class. This history allows the system to identify which standards have been adequately addressed, which remain unmet, and which may benefit from reinforcement. This record is also used to support curriculum-integrated progress tracking and adaptive sequencing. Additionally, the curriculum module 202 may integrate with reporting tools to provide visualizations of standard coverage across a student group, class, or school. When used in conjunction with performance analytics derived from the scoring module, the curriculum module helps the system identify instructional gaps and dynamically recommend new activities that maintain both horizontal alignment (across standards) and vertical progression (within a standard over time). In this way, the curriculum module 202 acts as a central coordinating engine, ensuring that every interaction between the learner and the system is both contextually grounded and instructionally relevant.

In one embodiment, the task module 204 is configured to generate and manage instructional tasks aligned with a curriculum, learning objective, or student goal. As used herein, a “task” may include one or more instructional activities that prompt the student to produce a language-based response, such as labeling, sentence completion, open-ended writing, or recorded speech. Tasks may be formative or summative in nature and may be delivered individually or as part of a structured progression or pathway. In one embodiment, each task is composed of several components, including (i) a visual prompt (e.g., an image), (ii) one or more text-based or audio prompts, (iii) scaffolding supports (e.g., word banks, sentence starters), and (iv) an expected response format (e.g., text, audio, or uploaded handwritten image).

In certain embodiments, the task module 204 receives input from the curriculum module 202, including one or more aligned standards, content topics, student learning goals, or grade-level expectations. Based on this input, the task module 204 queries an internal task database to identify matching tasks or generates new tasks dynamically. In one embodiment, the task module 204 uses AI to generate or select tasks in real time. For example, the task module 204 may identify a content-relevant image from a shared repository (e.g., an image of a plant in a science unit) and use an AI model trained on a corpus of instructional prompts to generate multiple prompt types: labeling questions, observation-based questions, inferential writing prompts, and argument prompts. The AI model may be conditioned on metadata such as student grade level, language proficiency level, learning objective type (e.g., descriptive vs. analytical), and scoring rubric requirements.

In one embodiment, the task module 204 is configured to scaffold tasks around a single image. For example, a task flow may begin with a simple labeling exercise using clickable image regions, followed by a sentence generation prompt (“Describe what is happening in the picture”), and finally a more complex writing or speaking task that requires explanation, comparison, or justification (“Explain why the leaves on the plant are wilting. Provide at least two reasons.”). The task module 204 may retrieve or generate each of these steps based on a progression model associated with the image, learning objective, or student performance history. This approach allows the same image to serve as the anchor for a multi-stage, level-appropriate instructional sequence.

In certain embodiments, the task module 204 uses AI to ensure that each task's complexity is appropriately leveled for the individual student. The task module 204 may receive performance data from the scoring module 210 indicating the student's proficiency across multiple indicators (e.g., vocabulary, grammar, fluency, pronunciation, interpretation). Using this data, the AI model may select prompt difficulty, task modality (speaking vs. writing), and scaffolding supports (e.g., sentence frames or key vocabulary hints). In one embodiment, the task module 204 may select from a historical database of teacher-authored prompts tagged by grade, domain, and rubric alignment, or it may generate new prompts using fine-tuned large language models that incorporate teacher-authored training data.

In one embodiment, the task module 204 receives input from the teacher-defined goal system described above. For example, if a teacher sets a goal for a student to improve their use of transition phrases in writing, the task module 204 may prioritize tasks that require sequencing events, making comparisons, or supporting claims with evidence. The task module 204 may embed sentence starters that reinforce transitional language (e.g., “First,” “Then,” “As a result,” “However”) and may assign rubrics that explicitly evaluate use of such structures. In this manner, the task module 204 generates instructional tasks that are not only aligned to standards and curriculum, but also responsive to user-specific goals and targeted skill development.

In some embodiments, the task module 204 supports both real-time assignment and pre-sequenced instructional “pathways.” As used herein, a pathway is a structured sequence of tasks designed to develop proficiency in a language modality (e.g., speaking) over time while remaining anchored in curriculum content. The task module 204 may build a pathway by chaining together tasks of increasing complexity or varied modality while maintaining consistent topical focus and standard alignment. For example, a pathway tied to a biology unit on photosynthesis might begin with labeling, advance to sentence completion, and culminate in a speaking task where the student explains a multi-step process using academic vocabulary. Pathways may be generated by AI based on student data or authored by educators using system tools.

In one embodiment, the task module 204 includes logic to adaptively reassign tasks based on student performance. For example, if a student underperforms on a speaking task tied to a specific standard, the task module 204 may select a lower-complexity follow-up task, reinforce the same skill using a different image prompt, or insert a focused practice activity targeting a particular language indicator (e.g., pronunciation). Conversely, if the student demonstrates mastery, the task module 204 may progress the student to a more advanced prompt or introduce a new standard-aligned objective. In this way, the task module 204 supports adaptive learning that responds to student performance in real time while maintaining rigorous alignment to instructional goals.

In one embodiment, the image module 205 is configured to select, retrieve, generate, or otherwise provide one or more visual prompts—herein referred to as “images”—for use in instructional tasks. An image may comprise a photograph, illustration, diagram, or composite visual intended to support language elicitation, comprehension, or explanation. The image module 205 operates in conjunction with the curriculum module 202 and task module 204 to ensure that selected images align with the learning objective, academic content area, and student proficiency level. For example, an image of a plant lifecycle may be selected for a third-grade science unit focused on photosynthesis, and then used to generate labeling, speaking, and writing tasks through the task module 204.

In some embodiments, the image module 205 accesses a curated database of content-aligned images that are pre-tagged by subject domain, vocabulary set, and instructional theme. In other embodiments, the image module 205 is configured to search third-party content repositories or receive user-uploaded images (e.g., from teachers). In such embodiments, the image module 205 may apply metadata extraction and classification techniques—including computer vision or image tagging algorithms—to automatically identify key features of an image and associate it with relevant curriculum standards or content topics. These tags may include elements such as scene type (e.g., classroom, natural environment), depicted objects (e.g., microscope, leaf), or thematic category (e.g., cause and effect, compare and contrast).

In one embodiment, the image module 205 is configured to generate instructional images using artificial intelligence, such as a generative adversarial network (GAN), a diffusion-based model, a transformer-based model, or another generative AI architecture. The AI model may be trained on a dataset of previously used or curated instructional images tagged with subject area, vocabulary themes, grade levels, and learning objectives. Upon receiving input parameters—such as a target curriculum standard, subject domain, or desired language outcome—the system may generate one or more images intended to prompt language elicitation aligned with that input.

For example, in response to a prompt to create an image suitable for a fifth-grade science standard on ecosystems, the AI model may synthesize an image depicting a food chain involving multiple organisms in a natural habitat. In some implementations, the generative process may be constrained by additional metadata such as rubric-aligned language indicators, student proficiency level, or task type (e.g., labeling, explanation, comparison). The generated image may be optionally reviewed by a human, verified by a content model, or evaluated using image classification heuristics to ensure it meets quality, accessibility, and pedagogical standards before being deployed in instructional tasks.

In certain embodiments, the image module 205 works in conjunction with the task module 204 to construct a “scaffolded image flow,” in which a single image is reused across multiple tasks of increasing complexity. For example, a labeling task may prompt the student to name objects in the image, followed by a sentence-completion task using provided vocabulary, and culminating in a speaking or writing task that requires full-sentence responses or explanations. The image module 205 may associate each image with a sequence of potential prompt types and difficulty levels, enabling the system to scaffold language development in a structured but flexible manner.

In one embodiment, the image module 205 includes functionality to embed interaction zones or “hotspots” within an image. These hotspots can be clicked or tapped to trigger specific instructional behaviors—for example, revealing vocabulary hints, triggering student labeling input, or anchoring specific sub-prompts. The image module 205 may generate these interaction zones dynamically based on object detection or semantic segmentation models applied to the image. In some cases, interaction zones may be manually defined by the teacher or inferred from prior student activity patterns.

In some embodiments, the image module 205 supports modality-specific adaptations. For instance, the image module 205 may pair a visual prompt with audio scaffolds for early language learners or associate it with simplified sentence starters in a student's native language to support L1-to-L2 transfer. Additionally, the image module 205 may select different versions of an image—such as cropped, blurred, or color-adjusted variants—based on age appropriateness, visual complexity, or instructional focus (e.g., focusing attention on a subset of relevant details).

The image module 205 may further maintain an association between each image and student performance data, enabling the system to track which images yield strong or weak language production across user groups. These data may be used to inform future task generation, curriculum planning, and personalization strategies. In some implementations, images that consistently lead to low performance may be automatically flagged for replacement, while high-performing images may be prioritized for use in future pathways.

In one embodiment, the assignment module 206 is configured to assign instructional tasks to users, including individual students, small groups, or entire classes. A task may be generated by the task module 204 or selected from a pre-existing set, and may be aligned to specific curriculum standards, learning goals, or language proficiency levels. The assignment module 206 may communicate with user profile data, including student grade level, performance history, and grouping information, to determine how and to whom each task should be distributed. In one embodiment, the assignment module 206 interfaces with a dashboard through which a teacher or administrator may initiate, review, or modify task assignments.

In certain embodiments, the assignment module 206 enables individualized task assignment, in which each student receives a task that has been adapted based on their most recent performance or an instructional goal. For example, a student who received low scores on grammatical accuracy in a prior speaking task may be assigned a follow-up task emphasizing grammatical structures, possibly using sentence frames or simplified syntax. Conversely, a high-performing student may receive a task with increased vocabulary complexity or an expanded reasoning requirement. The assignment module 206 may also incorporate feedback data—such as the indicators flagged in a scoring rubric—to guide which task to assign next.

In one embodiment, the assignment module 206 supports group-based assignment, allowing the system to automatically create instructional cohorts based on shared proficiency levels or skill focus areas. For instance, students with similar vocabulary deficiencies may be grouped and assigned a vocabulary-intensive speaking task based on the same image prompt. These groups may be static (predefined by a teacher or imported from a school information system) or dynamic, formed in real time based on scoring trends or AI clustering logic.

In certain embodiments, the assignment module 206 enables teacher-driven customization of tasks prior to assignment. A teacher may modify task parameters such as the image prompt, scaffold level (e.g., with or without sentence starters), task type (e.g., writing versus speaking), or scoring rubric. Teachers may also append additional instructions, select alternate prompt variants, or manually override the system's recommended task. The system may display preview options for each task variant before assignment to allow for informed customization.

In one embodiment, the assignment module 206 allows tasks to be delivered via multiple digital channels, such as a student-facing dashboard, email, secure link, QR code, or LMS integration. Once a task is assigned, the system may track delivery status, student access, time of submission, and completion metrics. In some embodiments, assignments may include deadlines, submission windows, or progress reminders configured by the teacher or system.

In one embodiment, the assignment module 206 includes logic for sequenced task assignment, wherein multiple tasks are pre-configured as a “pathway” and automatically assigned in a specified order. The order may reflect instructional logic defined in the curriculum (e.g., labeling→writing→explanation), or may be dynamically adjusted by the system based on performance on prior tasks. For example, if a student meets a proficiency threshold in a first speaking task, the assignment module 206 may immediately assign the next task in the sequence, skipping optional remedial activities.

In some embodiments, the assignment module 206 supports asynchronous and synchronous instruction modes. In asynchronous mode, tasks may be assigned for self-paced student completion; in synchronous mode, a task may be pushed to an entire group or class in real time, enabling teachers to facilitate whole-group modeling or guided practice. The assignment module 206 may include controls for task locking, progression gating, and visibility toggles to support these instruction modes.

In one embodiment, the assignment module 206 maintains a log of assigned tasks, including metadata such as assignment date, completion status, rubric alignment, and student-specific variants. This log may be used by the reporting module 212 to generate summaries of student progress across assignments, identify standards that have been addressed or are pending, and support compliance reporting for academic programs such as ELL funding audits or state ELD mandates.

In one embodiment, the response module 208 is configured to capture, receive, or ingest student responses to assigned tasks. A response may include a typed or written submission, a recorded audio file, a photograph of handwritten work, or a combination thereof. The response module 208 operates in coordination with the task module 204 and scoring module 210 to ensure that the captured input is correctly associated with the intended task, prompt, rubric, and user profile. In one embodiment, the response module 208 is accessible through a student-facing interface (e.g., web portal, app, LMS) that includes integrated input tools such as audio recording buttons, rich text fields, image upload tools, or camera access permissions.

In some embodiments, the response module 208 supports multi-modal input options to accommodate students at varying developmental levels, especially in early grades or for emerging bilinguals. For instance, the response module 208 may allow students to submit (i) typed responses, (ii) spoken responses recorded via built-in microphone tools, and/or (iii) photo uploads of physical writing artifacts (e.g., worksheet scans). In certain cases, the response module 208 may include a field for students to annotate or explain their photo-submitted work via voice or text, thereby enhancing the scoring context for that task.

In one embodiment, the response module 208 includes functionality to manage and normalize recorded audio responses. This may include detecting microphone input quality, prompting the user to re-record if the signal-to-noise ratio falls below a threshold, and confirming adequate response length or completion. The response module 208 may allow up to a fixed number of attempts (e.g., three) per prompt and may retain all attempts for later scoring or teacher review. Audio files may be stored with associated metadata including task ID, prompt version, timestamp, and student ID for traceability.

In certain embodiments, the response module 208 preprocesses captured responses to facilitate automated scoring. For written responses, this may include tokenization, spell correction, grammar parsing, and vector embedding. For audio responses, the response module 208 may convert speech to text using automatic speech recognition (ASR) and extract prosodic and phonemic features relevant to scoring indicators (e.g., pronunciation, fluency). The raw and processed data may then be passed to the scoring module 210 for evaluation. The response module 208 may also preserve the original response file as part of an audit trail.

In one embodiment, the response module 208 supports cross-modal reinforcement, wherein a student's written and spoken responses are both considered for a single task or series of tasks. For example, a student may be asked to complete a writing prompt and then read their response aloud for pronunciation scoring. The response module 208 may associate the two submissions as part of an integrated record and link both to the same rubric indicators. This feature supports holistic evaluation of language proficiency across modalities and reinforces learning through repetition and multi-sensory processing.

In some embodiments, the response module 208 includes tools for upload validation and quality assurance. For example, when a student submits a photo of handwritten work, the response module 208 may assess image clarity, detect orientation, and confirm that handwriting is present using computer vision models. If the submission is invalid (e.g., blurry, blank, or upside-down), the response module 208 may prompt the student to resubmit or alert a teacher for manual review. The response module 208 may also run checks on file size, format compliance, and duplication before accepting the submission.

In one embodiment, the response module 208 may support real-time progress tracking during task completion. For instance, the response module 208 may display visual indicators (e.g., recording in progress, upload complete) and confirm when the student has met submission criteria. In some implementations, the response module 208 may provide instant feedback on submission completeness or trigger next-step recommendations (e.g., “Now try explaining this image in your own words”) based on detected response features.

The response module 208 may also communicate with the reporting module 212 to record timestamps, submission artifacts, and input types for each task. This information may be used to generate longitudinal records of student engagement, modality preference trends, or submission reliability across time. Additionally, it may serve compliance and reporting purposes in educational contexts where documentation of student work is required.

In one embodiment, the scoring module 210 is configured to evaluate user responses-whether spoken, written, or uploaded images-according to a set of language proficiency indicators. The scoring module 210 may apply both automated and human-assisted methods to assign performance scores, sub-scores, and feedback aligned with one or more rubrics. Each rubric may correspond to a particular task type (e.g., writing, speaking), language modality, or grade-level standard and may be aligned to official language development assessments such as WIDA, ELPAC, or ACCESS. The scoring module 210 may operate in coordination with the response module 208 to retrieve raw or pre-processed user input, and with the reporting module 212 to format scores into user-facing feedback or dashboards.

In one embodiment, the scoring module 210 uses structured rubrics that include multiple indicator dimensions for each modality. For speaking, these may include pronunciation, fluency, vocabulary, grammar, and interpretation. For writing, indicators may include vocabulary and grammar, descriptive explanation, and evidence-based reasoning. Each indicator may be independently scored on a multi-level proficiency scale (e.g., 1-4) and then aggregated into a composite score for the modality or task. In some embodiments, rubric alignment may be state-specific and tuned to the performance thresholds and scoring expectations of regional assessments.

In certain embodiments, the scoring module 210 includes an AI-based auto-scoring engine trained on a proprietary corpus of annotated student responses. This training data may include audio and text samples, scored by experienced human raters, across various grade levels and rubric dimensions. The AI engine may evaluate written responses by analyzing syntax, grammar accuracy, lexical variety, and coherence using NLP models. For spoken responses, the engine may extract features such as speech rate, filler word frequency, prosodic variation, and phoneme accuracy. These features may be processed using classification or regression models to produce indicator-level scores.

In one embodiment, the scoring module 210 incorporates a quality assurance loop that compares AI-generated scores with human-assigned scores to ensure reliability. If the system detects a discrepancy between AI and human ratings beyond a predefined tolerance threshold, the task may be flagged for review by a senior rater. The scoring module 210 may also use this comparison to continuously refine the AI model and update calibration parameters. In some cases, the scoring module 210 may track inter-rater reliability and use this data to weight scores or prioritize certain feedback pathways.

In some embodiments, the scoring module 210 is further configured to provide calibrated anchor responses to aid both human raters and machine learning models. These anchors may include sample audio or written responses with known indicator scores, which serve as benchmarks for consistent evaluation. The scoring module 210 may dynamically update or reclassify anchor responses based on evolving rubric interpretations, rubric revisions, or new student data patterns.

In one embodiment, the scoring module 210 generates formative and summative feedback as part of the scoring process. This feedback may include textual descriptions of strengths and areas for improvement, recommendations for next steps, and links to relevant follow-up tasks. For example, a student who scored low on fluency may receive a message such as “Try speaking for a longer duration without pauses-use your notes to organize your ideas before recording.” This feedback may be configured to align directly with rubric indicators and may vary in complexity based on grade level or user profile.

In some embodiments, the scoring module 210 supports rubric customization or selection by educators or administrators. A teacher may choose from preset rubrics aligned with state standards, upload a custom rubric, or adjust scoring weights for specific indicators. The scoring module 210 may then apply the customized rubric to auto-scoring or human review workflows and adapt the structure of the scoring interface accordingly.

In one embodiment, the scoring module 210 also maintains a longitudinal scoring history for each user, capturing performance trends across indicators, task types, and instructional units. This history may be used by the task module 204 or assignment module 206 to drive adaptive instructional logic—e.g., by adjusting future task difficulty or targeting underperforming indicators. The scoring data may also feed into predictive analytics for estimating year-end proficiency levels or assessment readiness.

The scoring module 210 may also output structured data to the reporting module 212, which formats and visualizes the scores for display to students, teachers, and administrators. Scores may be exported for progress monitoring, compliance reporting, parent-teacher communication, or integration with external systems such as student information systems (SIS) or learning management systems (LMS).

In one embodiment, the reporting module 212 is configured to generate, compile, and display reports based on user responses, performance scores, rubric indicators, and instructional history. The reporting module 212 may serve multiple audiences, including students, teachers, administrators, and school or district-level staff. Reports may be generated in real time as tasks are scored and may reflect a variety of data types, including quantitative rubric scores, qualitative feedback, task completion rates, proficiency trends, and curriculum standard coverage.

In one embodiment, the reporting module 212 generates student-facing reports that include individual task results, performance breakdowns by language indicator (e.g., grammar, vocabulary, fluency), and actionable feedback. Reports may include visual elements such as progress bars, proficiency level badges, and score history graphs. In certain embodiments, the reporting module 212 displays aspirational model responses—either human- or AI-generated—that exemplify the next level of performance for a given task. For instance, a student who receives a level 2 score on “fluency” may be shown a sample response that illustrates what a level 3 answer sounds or reads like. This supports student motivation and provides concrete models for improvement.

In some embodiments, the reporting module 212 generates teacher-facing dashboards that aggregate performance across students, tasks, and instructional units. These dashboards may display trends in indicator-level performance, highlight common areas of weakness across a class, and flag students who may need intervention. Teachers may drill down from class-level summaries to individual student reports, or filter by curriculum standard, language domain, or assignment type. In certain embodiments, the module displays standard alignment coverage, showing which standards have been addressed through completed tasks and which remain unaddressed, partially covered, or unmet.

In one embodiment, the reporting module 212 enables group-level and administrative reporting across classrooms, schools, or districts. These reports may support program monitoring (e.g., for English Language Learners), funding compliance (e.g., Title III), or instructional planning. Reports may be exportable in structured formats (e.g., CSV, PDF, XLSX) and may include aggregate statistics, distribution charts, and proficiency progression analyses across time.

In certain embodiments, the reporting module 212 tracks performance data for each user, linking tasks to standards, indicators, and feedback across time. This enables teachers and students to view growth trajectories, set personalized goals, and reflect on prior work. For example, a student may be able to view how their “interpretation” scores in speaking have evolved over a semester, tied to specific tasks and feedback entries. The system may also generate progress alerts (e.g., “Student has improved two levels in grammar since mid-year”) or suggest when to reassess a prior standard.

In one embodiment, the reporting module 212 supports bilingual or multimodal report output, allowing reports to be generated in a student's native language or rendered in audio, visual, or simplified text formats. This ensures accessibility for early language learners and supports communication with families and guardians. Reports may also include teacher- or system-generated annotations, progress milestones, and next-step recommendations.

In some embodiments, the reporting module 212 integrates with external systems such as learning management systems (LMS), student information systems (SIS), or assessment platforms. This allows for seamless data flow between Flashlight Learning and other tools in the educational ecosystem. For example, a student's rubric-aligned speaking score may be pushed to a gradebook, or an administrator may import benchmark data to validate predicted assessment outcomes.

In one embodiment, the reporting module 212 is also configured to support predictive analytics, such as forecasting a student's likely performance on an end-of-year language development assessment. These predictions may be based on historical task scores, growth rate, benchmark performance, and scoring consistency. The system may visualize predicted proficiency levels and flag potential at-risk students for intervention planning.

In one embodiment, the system includes an AI module 214 that is configured to generate, train, and iteratively refine one or more machine learning models used within the system. The AI module 214 may be integrated with, or accessible by, various subsystems including the task module 204, image module 205, assignment module 206, response module 208, scoring module 210, and reporting module 212. Each model may be trained to perform a specific task, such as generating prompts, scoring student responses, predicting proficiency outcomes, recommending instructional resources, or generating aligned images. The AI module 214 may include tools for dataset preparation, model architecture selection, training workflow orchestration, evaluation, and deployment.

In one embodiment, the AI module 214 generates a model by selecting a machine learning architecture based on the type of problem being solved—e.g., transformer-based models for text generation, convolutional neural networks (CNNs) or diffusion models for image generation, or regression/classification models for scoring prediction. The AI module 214 may initialize the model with pretrained weights (e.g., from publicly available foundation models) and fine-tune the model using proprietary domain-specific data. For instance, the scoring model may be fine-tuned on a historical dataset of student responses (audio and text) paired with human-assigned rubric scores.

In some embodiments, the AI module 214 includes a data curation pipeline for constructing training datasets. The pipeline may ingest student task data, teacher-authored prompts, scoring rubrics, feedback entries, and other structured metadata. For supervised tasks, the AI module 214 may identify input-output pairs such as: (i) a prompt and corresponding high- or low-scoring student response; (ii) an image and a set of grade-level-appropriate questions; or (iii) a set of proficiency indicators and a predicted assessment outcome. In some cases, the pipeline includes human-in-the-loop verification steps to ensure labeling accuracy and bias control.

In one embodiment, the AI module 214 supports model refinement and retraining using newly acquired or evolving data. For example, the system may collect data over time as students complete new tasks, receive scores, and improve their performance. The AI module 214 may periodically retrain models using this updated dataset to ensure that feedback, scoring, or task recommendations remain aligned with current instructional practices, assessment standards, and student performance patterns. Retraining may be scheduled (e.g., monthly) or triggered dynamically by observed performance drift, model degradation, or significant curriculum changes.

In certain embodiments, the AI module 214 includes model evaluation tools to assess accuracy, generalization, and fairness. These tools may measure model performance using metrics such as precision, recall, F1 score, scoring consistency (e.g., rater agreement), or rubric alignment fidelity. The AI module 214 may apply validation on hold-out sets, conduct A/B testing between model versions, or run model scoring alongside human raters to ensure reliability. Evaluation results may be used to select the best-performing version for deployment or rollback a model to a prior stable state.

In one embodiment, the AI module 214 also includes deployment and integration capabilities that allow trained models to be embedded into operational workflows. For example, a scoring model may be deployed into the scoring module 210 via an API or runtime container, and used to score responses in real time. A prompt generation model may be embedded within the task module 204 to dynamically create sentence starters or reading passages. The AI module 214 may manage model versioning, deployment endpoints, and performance monitoring during live operation.

In some embodiments, the AI module 214 maintains a model registry that records training parameters, data lineage, model weights, training set size, rubric versions, and performance metrics. This registry allows for traceability and reproducibility of model behavior, especially in educational or regulated environments. The system may use this registry to compare model versions, conduct audits, and support explainability or transparency requirements.

In one embodiment, the AI module 214 enables cross-model coordination by sharing learned representations or performance signals between models. For instance, a scoring model may provide language performance data that informs an adaptive learning model responsible for task selection. A proficiency prediction model may be trained using indicator-level outputs from the scoring model as input features. In this way, the AI module 214 facilitates interoperability and data reuse across AI components within the system.

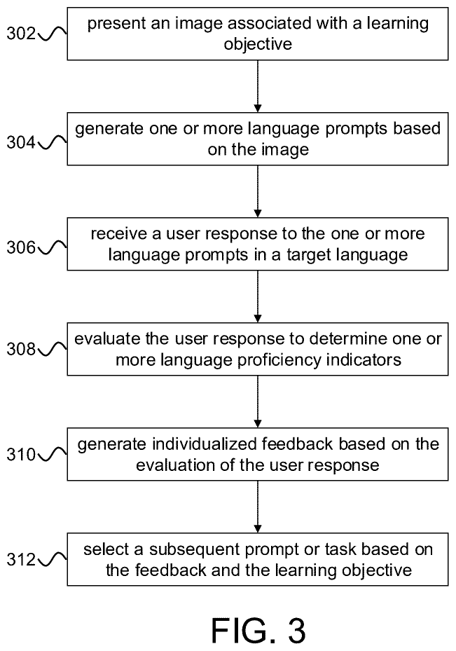

FIG. 3 illustrates one embodiment of a method for language learning. The method may be performed by an information handling device 102, a server 108, a learning apparatus 104, a curriculum module 202, a task module 204, an image module 205, an assignment module 206, a response module 208, a scoring module 210, a reporting module 212, and/or an AI module 214.

In one embodiment, the method begins and presents 302 an image associated with a learning objective. In one embodiment, the method generates 304 one or more language prompts based on the image. In one embodiment, the method receives 306 a user response to the one or more language prompts in a target language. In one embodiment, the method evaluates 308 the user response to determine one or more language proficiency indicators. In one embodiment, the method generates 310 individualized feedback based on the evaluation of the user response. In one embodiment, the method selects 312 a subsequent prompt or task based on the feedback and the learning objective, and the method ends.

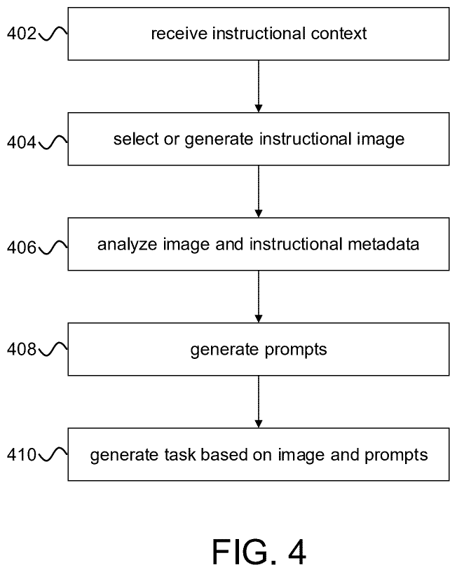

FIG. 4 illustrates one embodiment of a method for language learning. The method may be performed by an information handling device 102, a server 108, a learning apparatus 104, a curriculum module 202, a task module 204, an image module 205, an assignment module 206, a response module 208, a scoring module 210, a reporting module 212, and/or an AI module 214.

In one embodiment, the method begins and receives 402 instructional context such as input specifying the learning objective, curriculum standard, content domain (e.g., science, social studies), grade level, and/or student proficiency level. In one embodiment, the method selects or generates 404 an instructional image. For instance, the method may locate an image from a curated repository or, if no suitable match is found, generates an image using a generative AI model (e.g., GAN or diffusion-based). The image may be tagged with metadata such as theme, vocabulary set, and difficulty level.

In one embodiment, the method analyzes 406 the image and instructional metadata. The selected or generated image, for example, is paired with the learning objective and analyzed to determine instructional affordances—such as objects depicted, relevant verbs/nouns, or cognitive task level (e.g., describe, explain, justify). In one embodiment, the method generates 408 prompts, e.g., using the image and contextual metadata. The prompts may include labeling instructions, open-ended questions, sentence starters, or reading passages that are tailored to the student's level and aligned to the standard. In one embodiment, the method generates 410 tasks based on the image and the prompts. The image and generated prompt(s) may be packaged into a task object that includes task type (e.g., speaking, writing), scaffold options (e.g., word bank, sentence frame), and rubric alignment data, and the method ends.

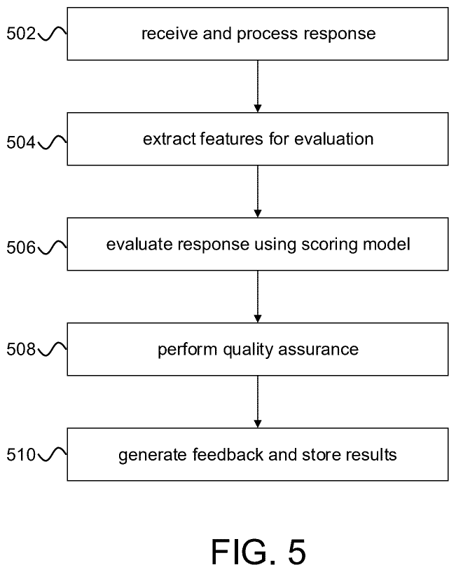

FIG. 5 illustrates one embodiment of a method for language learning. The method may be performed by an information handling device 102, a server 108, a learning apparatus 104, a curriculum module 202, a task module 204, an image module 205, an assignment module 206, a response module 208, a scoring module 210, a reporting module 212, and/or an AI module 214.

In one embodiment, the method begins and receives 502 and processes a response. For example, the method may receive a response from the student-either typed/written (writing), recorded (speaking), or uploaded (handwritten image). If needed, the method transcribes speech using speech recognition or digitizes handwriting using OCR. In one embodiment, the method extracts 504 features for evaluation, e.g., based on modality and rubric-grammar, vocabulary variety, fluency, pronunciation, sentence structure, and coherence.

In one embodiment, the method evaluates 506 the response using a scoring model. For instance, the extracted features are evaluated using one or more AI models trained on labeled student responses. The method may generate individual indicator scores (e.g., vocabulary: 3, grammar: 2, fluency: 4) and an overall proficiency score. In one embodiment, the method performs 508 quality assurance for the evaluation. For example, the method may compare AI scores with any available human scores. If the scores diverge beyond a set tolerance, the response is flagged for human review, re-scoring, or model refinement.

In one embodiment, the method generates 510 feedback and stores the results. Based on the scores, the method generates individualized feedback linked to rubric indicators (e.g., “Add more detail to support your explanation”). Scores and feedback are stored and sent to the reporting module for visualization and tracking, and the method ends.

In one embodiment, an apparatus is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

In one embodiment, the apparatus is configured to select or generate the image based on the learning objective and a learning level. In one embodiment, the prompts comprise one or more of labeling prompts, sentence starters, open-ended questions, or reading passages.

In one embodiment, the user response comprises at least one of a written response or a spoken response. In one embodiment, evaluating the user response comprises scoring the response against a rubric that includes multiple language proficiency indicators. In one embodiment, the language proficiency indicators comprise one or more of vocabulary, grammar, fluency, pronunciation, or interpretation.

In one embodiment, the individualized feedback comprises at least one suggestion for improvement aligned to the learning objective. In one embodiment, selecting a subsequent prompt or task comprises adjusting a difficulty level or content domain of the task based on a user's prior performance.

In one embodiment, the apparatus is configured to display a user's scores, feedback, and progress over time. In one embodiment, the image is reused across a sequence of tasks to progressively elicit user responses of increasing complexity, including labeling, sentence generation, and explanation.

In one embodiment, the user response comprises a photograph of a handwritten submission. In one embodiment, the apparatus is configured to align tasks and feedback to curriculum standards associated with an educational institution. In one embodiment, the image is selected by a teacher and the prompts are generated based on the image and a student's learning level.

In one embodiment, evaluating the user response comprises using one or more machine learning models trained on historical student response data. In one embodiment, generating the one or more prompts comprises selecting or creating prompts using artificial intelligence based on the image and a student's performance level.

In one embodiment, selecting a subsequent prompt or task comprises applying an adaptive learning model configured to adjust instructional progression based on prior task responses. In one embodiment, the apparatus is configured to estimate a user's performance on a standardized assessment by applying a predictive model trained on benchmark assessment data.

In one embodiment, evaluating the user response includes verifying a consistency of a human score against a score that is generated using artificial intelligence and flagging discrepancies for review.

In one embodiment, a method is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

In one embodiment, a computer program product includes a non-transitory computer-readable storage medium that stores program code that, when executed by one or more processors, is configured to present an image associated with a learning objective, generate one or more language prompts based on the image, receive a user response to the one or more language prompts in a target language, evaluate the user response to determine one or more language proficiency indicators, generate individualized feedback based on the evaluation of the user response, and select a subsequent prompt or task based on the feedback and the learning objective.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a memory; and
a processor coupled with the memory and configured to cause the apparatus to:
present an image associated with a learning objective;
generate one or more language prompts based on the image;
receive a user response to the one or more language prompts in a target language;
evaluate the user response to determine one or more language proficiency indicators;
generate individualized feedback based on the evaluation of the user response; and
select a subsequent prompt or task based on the feedback and the learning objective.

2. The apparatus of claim 1, wherein the processor is configured to cause the apparatus to select or generate the image based on the learning objective and a learning level.

3. The apparatus of claim 1, wherein the prompts comprise one or more of labeling prompts, sentence starters, open-ended questions, or reading passages.

4. The apparatus of claim 1, wherein the user response comprises at least one of a written response or a spoken response.

5. The apparatus of claim 1, wherein evaluating the user response comprises scoring the response against a rubric that includes multiple language proficiency indicators.

6. The apparatus of claim 5, wherein the language proficiency indicators comprise one or more of vocabulary, grammar, fluency, pronunciation, or interpretation.

7. The apparatus of claim 1, wherein the individualized feedback comprises at least one suggestion for improvement aligned to the learning objective.

8. The apparatus of claim 1, wherein selecting a subsequent prompt or task comprises adjusting a difficulty level or content domain of the task based on a user's prior performance.

9. The apparatus of claim 1, wherein the processor is configured to display a user's scores, feedback, and progress over time.

10. The apparatus of claim 1, wherein the image is reused across a sequence of tasks to progressively elicit user responses of increasing complexity, including labeling, sentence generation, and explanation.

11. The apparatus of claim 1, wherein the user response comprises a photograph of a handwritten submission.

12. The apparatus of claim 1, wherein the processor is configured to cause the apparatus to align tasks and feedback to curriculum standards associated with an educational institution.

13. The apparatus of claim 1, wherein the image is selected by a teacher and the prompts are generated based on the image and a student's learning level.

14. The apparatus of claim 1, wherein evaluating the user response comprises using one or more machine learning models trained on historical student response data.

15. The apparatus of claim 1, wherein generating the one or more prompts comprises selecting or creating prompts using artificial intelligence based on the image and a student's performance level.

16. The apparatus of claim 1, wherein selecting a subsequent prompt or task comprises applying an adaptive learning model configured to adjust instructional progression based on prior task responses.

17. The apparatus of claim 1, wherein the processor is configured to cause the apparatus to estimate a user's performance on a standardized assessment by applying a predictive model trained on benchmark assessment data.

18. The apparatus of claim 1, wherein evaluating the user response includes verifying a consistency of a human score against a score that is generated using artificial intelligence and flagging discrepancies for review.

19. A method comprising:
presenting an image associated with a learning objective;
generating one or more language prompts based on the image;
receiving a user response to the one or more language prompts in a target language;
evaluating the user response to determine one or more language proficiency indicators;
generating individualized feedback based on the evaluation of the user response; and
selecting a subsequent prompt or task based on the feedback and the learning objective.

20. A computer program product comprising a non-transitory computer-readable storage medium storing program code that, when executed by one or more processors, performs operations comprising:
presenting an image associated with a learning objective;
generating one or more language prompts based on the image;
receiving a user response to the one or more language prompts in a target language;
evaluating the user response to determine one or more language proficiency indicators;
generating individualized feedback based on the evaluation of the user response; and
selecting a subsequent prompt or task based on the feedback and the learning objective.
